(19) United States
(12) Patent Application Publication
(10) Pub. No.: US 2017/0118447 A1
(43) Pub. Date: Apr. 27, 2017

(54) ROBOT ARM WITH IMAGE CAPTURING FUNCTION

(71) Applicant: QUANTA STORAGE INC., Taoyuan City (TW)

(72) Inventors: Shih-Jung Huang, Taoyuan City (TW); Szu-Hung Wang, Taoyuan City (TW); Pei-Jui Wang, Taoyuan City (TW)

(21) Appl. No.: 15/283,448

(22) Filed: Oct. 3, 2016

(30) Foreign Application Priority Data
Oct. 26, 2015 (CN) 201510700701.0

(51) Int. Cl. H04N 7/18; B25J 19/02; H04N 5/232

(52) U.S. Cl. CPC H04N 7/185; H04N 5/23245; B25J 19/023

(57) ABSTRACT

A robot arm with an image capturing function includes a body, a capture control device, a controller, and a display. When the robot arm is in an operation mode, the controller automatically controls the body to move a movable portion at one terminal of the body to move an eye in hand device disposed on the movable portion to capture images and search for objects. When the robot arm is in a manual mode, the movable portion is moved manually, and the capture control device next to the eye in hand device is controller manually to activate the eye in hand device to capture images and generate image files of predetermined objects, thereby simplifying the operation process of robot arm.

### BACKGROUND OF THE INVENTION

1. Field of the Invention

This invention relates to a robot arm, especially relates to a robot arm with an image capturing function.

2. Description of the Prior Art

In factories, robot arms are usually used for increasing the efficiency of production. Smart robot arms can be installed with visual devices to detect the external environment or features of objects for avoiding obstacles or planning the moving paths automatically, thereby improving the production efficiency of the automatic production process.

FIG. 8 shows a robot arm 1 of prior art. During automatic operations, the controller 2 controls the robot arm 1 to move the eye in hand (EIH) device 3 to capture an image of the external environment and stores the image to the memory 4 temporarily. Then, the controller 2 controls the image processor 5 to process the image stored in the memory 4. The processed images are compared with the image file of a target object 6 stored in the memory 4 previously for identification. If the target object 6 is identified in the processed image, the controller 2 controls the robot arm 1 to pick up and put down the target object 6 automatically.

For the image file of the object 6 stored in the memory 4, the prior art uses an external camera 7 to capture the image of object 6, and processes the image by an external image processor 8 to generate its image file including the characteristic information relating to the shape and the size of the object 6. The external image processor is connected to the interface 9 of the robot arm 1, thereby transmitting the image file from the external image processor 8 to the robot arm 1. After the controller 2 receives the image file, the file is stored to the memory 4 temporarily, and is shown on the display 10. The image file of the object 6 is classified manually and stored to the memory 4 for the use of future identification.

In the prior art, the robot arm 1 uses the external camera 7 and the external image processor 8 to generate and process the image file of the object 6. However, the external image processor may require higher processing ability. Also, to transfer the image file of the object 6 and to store the image file to the robot arm 1 may need professional techniques. The complicate processes may become obstacles for a general user and may lower the production efficiency. Therefore, there are still issues to be solved for the image capturing and processing on the robot arm.

### SUMMARY OF THE INVENTION

One embodiment of the present invention discloses a robot arm with an image capturing function. The robot arm includes a body, a capture control device, a controller, and a display.

The body has a first terminal fixed at a base, and a second terminal being a movable portion. The movable portion has an eye in hand device disposed thereon. The capture control device is disposed next to the eye in hand device and activates the eye in hand device to capture images. The controller is coupled to the body and controls the body to move the movable portion. The display is controlled by the controller and is used for displaying images captured by the eye in hand device.

When the robot arm is in an operation mode, the controller controls the eye in hand device to capture images. When the robot arm is in a manual mode, the capture control device activates the eye in hand device to capture images.

Another embodiment of the present invention discloses a method for using a robot arm to capture images. The method includes switching the robot arm to a manual mode, moving the robot arm manually to bring an eye in hand device close to a target object, a display displaying an image captured by the eye in hand device, a capture control device activating the eye in hand device to capture an image of the target object when the target object shows up in the display, storing the image of the target object temporarily, processing the image of the target object to generate an image file of a predetermined object, storing the image file in a memory, switching the robot arm to an operation mode, the robot arm controlling the eye in hand device to capture an image of an object, and identifying the object according to the image file of the predetermined object.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a robot arm according to one embodiment of the present invention.

FIG. 2 shows the function blocks of the robot arm in FIG. 1.

FIG. 3 shows a target object on a machine.

FIG. 4 shows an image of the target object in FIG. 3 shown in the display of the robot arm in FIG. 1.

FIG. 5 shows a flow chart of the method for using a robot arm to capture images according to one embodiment of the present invention.

FIG. 6 shows a robot arm according to another embodiment of the present invention.

FIG. 7 shows an upper portion of a movable portion of the robot arm in FIG. 6.

FIG. 8 shows a robot arm of prior art.

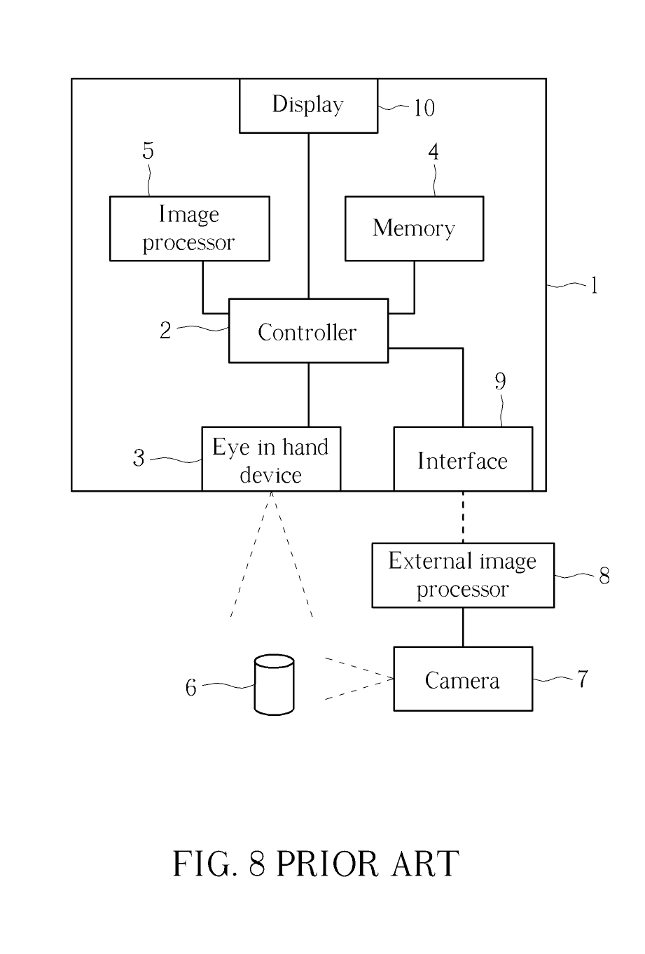

### DETAILED DESCRIPTION

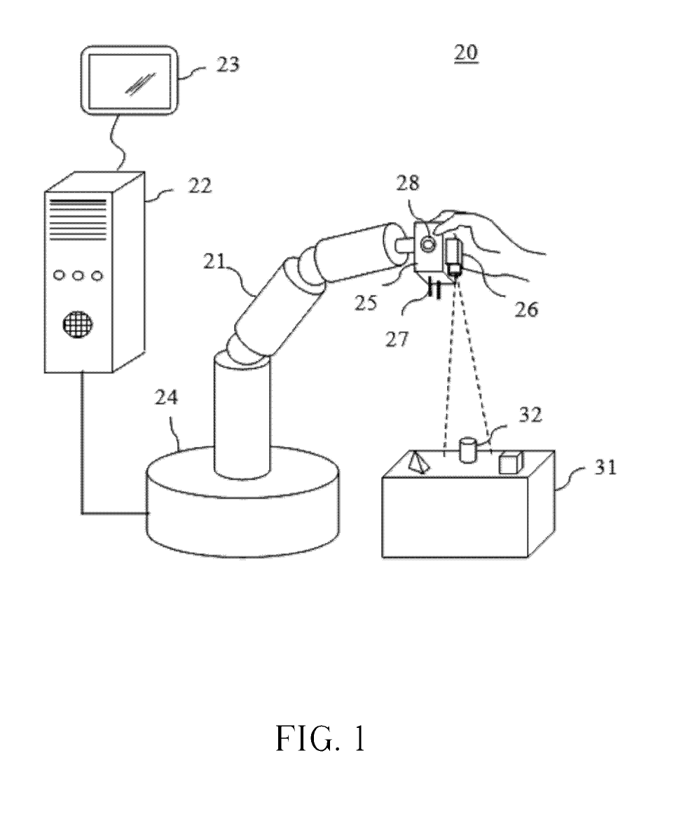

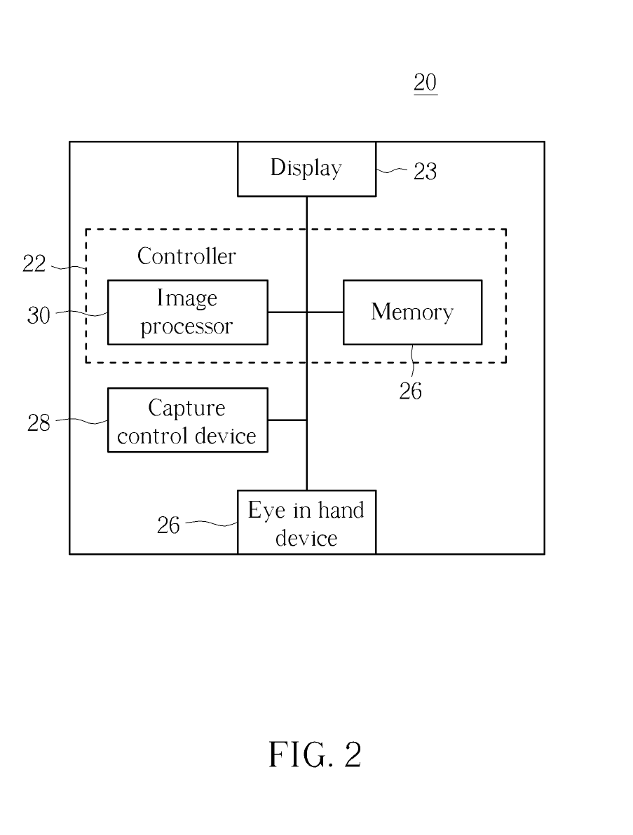

FIG. 1 shows a robot arm 20 according to one embodiment of the present invention. FIG. 2 shows the function blocks of the robot arm 20. The robot arm 20 includes a body 21, a controller 22, and a display 23. The body 21 has a terminal fixed at a base 24, and a terminal being a movable portion 25. The movable portion 25 has an eye in hand device 26 disposed thereon, and a clamp claw 27 for clamping objects. A capture control device 28 is disposed next to the eye in hand device 26 on the movable portion 25. The capture control device 28 can be a push button or a switch. The capture control device 28 is for activating the eye in hand device 26 manually to capture images.

The controller 22 of the robot arm 20 is connected to the body 21. The controller 22 includes the memory 29 and the image processor 30. The memory 29 is controlled by the controller 22 for storing image files of predetermined objects beforehand and storing images captured by the eye in hand device 26 temporarily. The image processor 30 is controlled by the controller 22 for processing the images temporarily stored in the memory 29. Also, the display 23 is controlled by the controller 22 for displaying the images captured by the eye in hand device 26 on the robot arm 20 and the user interface.

When the robot arm 20 is in an operation mode, the controller 22 controls the body 21 to move the eye in hand device 26 and the clamp claw 27 on the movable portion 25. The controller 22 controls the eye in hand device 26 to capture images of the working environment surrounding the robot arm 20, and controls the display 23 to display the captured images for searching a target object 32 on a machine 31 in the working environment. When the object 32 is captured by the eye in hand device 26, the image containing the object 32 captured by the eye in hand device 26 is stored to the memory 29 temporarily. The controller 22 controls the image processor 30 to process the image temporarily stored in the memory 29, and compares the image with the image files of the predetermined objects stored in the memory 29 previously to identify if the object 32 is the targeted object. If the object 32 is the target object, then the controller 22 drives the movable portion 25 of the robot arm 20 to approach the object 32, and clamps the object 32 by the clamp claw 27 for processing the following assembling or transferring process.

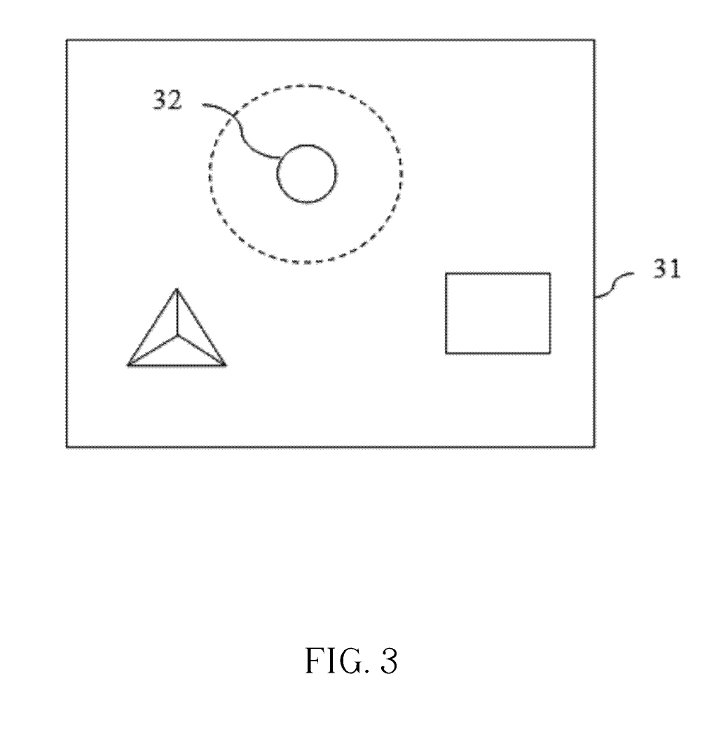

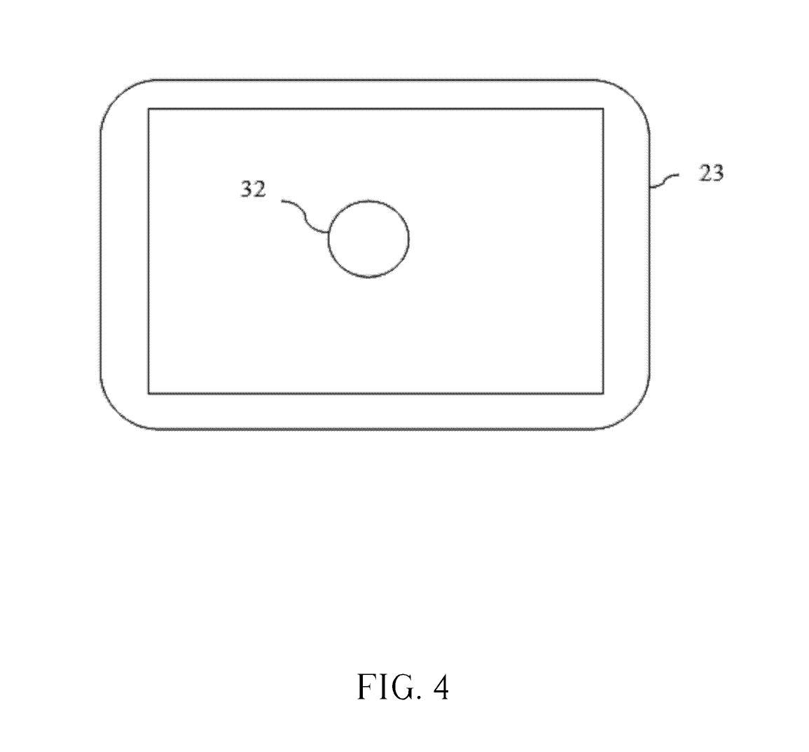

FIG. 3 shows the target object on the machine 31, and FIG. 4 shows the image of the target object shown in the display 23. When the robot arm 20 is switched to a manual mode, the eye in hand device 26 is controlled by the capture control device 28 to capture images. By moving the movable portion 25 manually, the eye in hand device 26 on the movable portion 25 can approach the object 32 and make the object 32 appear in the view window of the eye in hand device 26 as the dotted line shown in FIG. 3. Therefore, the object 32 would be displayed on the display 23. The operator can see the object 32 displayed on the display 23 and confirm if the object 32 is the target object. The operator can further clear the unrelated objects out of the view window of the eye in hand device 26, and ensure that the target object 32 remains in the view window completely. In this case, the operator can hold the eye in hand device 26 at a fixed position to capture the image of the target object 32 shown on the display 23, and can control the capture control device 28 without leaving the robot arm 20 for operating other devices. Also, the operator may capture images of the target object 32 from multiple angels. After the eye in hand device 26 captures the image of the target object 32, the image is stored to the memory 29 temporarily and processed by the image processor 30 under the control of the controller 22. The image processor 30 processes the image of the target object 32 to generate the image file of a predetermined object, and image file of the predetermined object is stored to the memory 29 for future identification.

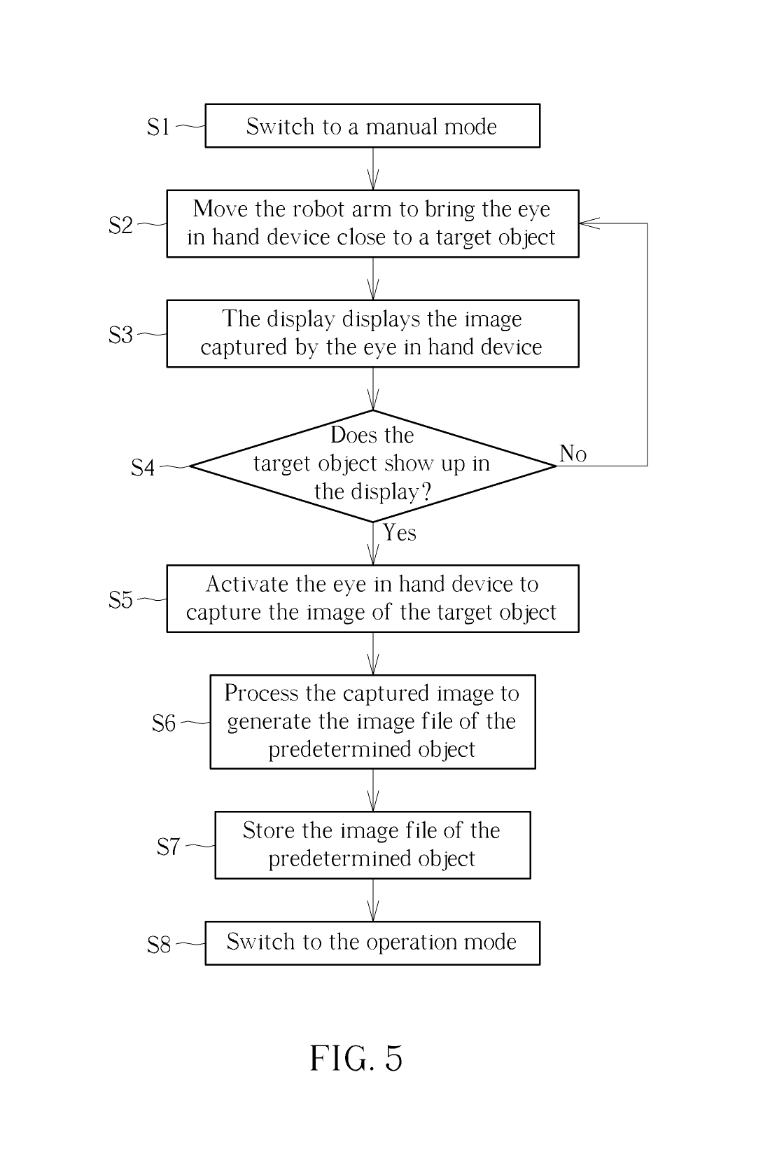

FIG. 5 shows a flowchart of the method for using a robot arm to capture images according to one embodiment of the present invention. The method for using the robot arm to capture images includes steps S1 to S7. In step S1, the robot arm is switched to a manual mode. In step S2, the robot arm is moved manually to bring the eye in hand device close to a target object. In step S3, the display displays the image captured by the eye in hand device. Step S4 would check whether the target object shows up in the display or not. If the target object does not show up in the display, go back to step S2, and continue moving the robot arm to bring the eye in hand device close to the target object. Otherwise, if the target object shows up in the display, go to step S5 to control the capture control device to activate the eye in hand device to capture the image of the target object. In step S6, the captured image of the target object is stored to the memory of the robot arm temporarily and is processed to generate the image file of the predetermined object. In step S7, the image file of the predetermined object is stored to the memory. In step S8, the robot arm is switched to the operation mode, and the robot arm can control the eye in hand device to capture images of objects automatically and identify the objects according to the image file of the predetermined object stored previously.

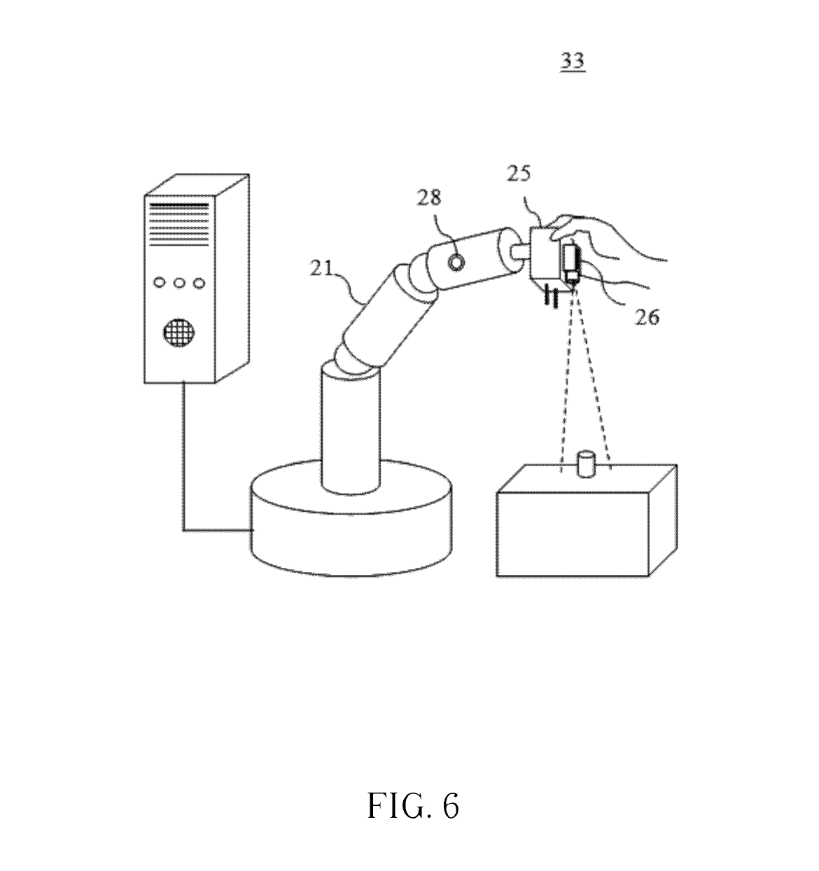

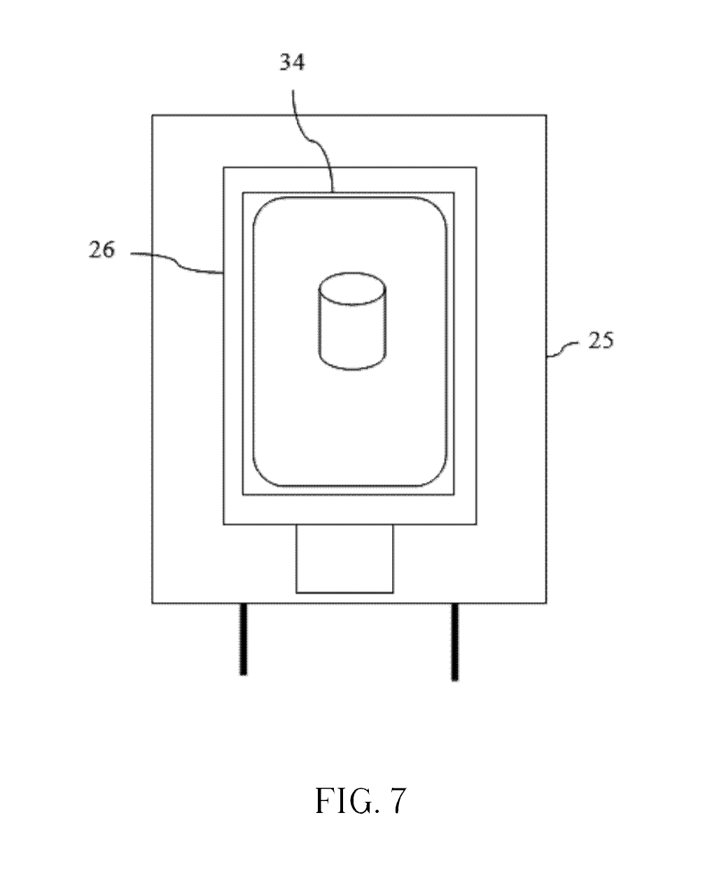

FIG. 6 shows the robot arm 33 according to another embodiment of the present invention, and FIG. 7 shows the upper portion of the movable portion of the robot arm 33 in FIG. 6. The robot arm 33 and the robot arm 20 have similar structures; however, the displays and the captured control devices of the robot arm 33 and the robot arm 20 are disposed in different positions. In the robot arm 20, the capture control device is disposed next to the movable portion 25. For example, when moving the movable portion 25 manually, the operator may use one hand to hold the eye in hand device 26 at a fixed position, and use another hand to control the capture control device 28 to active the eye in hand device 26 for capturing images without affecting the position of the eye in hand device 26. However, the present invention is not limited to the robot arm 20 as shown in FIG. 1. In FIG. 6, the capture control device 28 is disposed on the body 21 next to the eye in hand device 26 of the robot arm 33. Therefore, the operator can still use one hand to hold the eye in hand device 26 at a fixed position and use another hand to control the capture control device 28 to active the eye in hand device 26 for capturing images without affecting the position of the eye in hand device 26, thereby making it easy to control the capture control device 28 to activate the eye in hand device 26 for capturing images. Furthermore, in FIG. 7, the display 34 is disposed on the eye in hand device 26 directly. Therefore, when moving the movable portion 25, the operator can see the display and focus on adjusting the eye in hand device 26 at the same time. In addition, the display 34 can be disposed in parallel with the view of the eye in hand device 26 so the moving direction of an object shown in the display would be intuitively corresponding to the moving direction of the eye in hand device 26, thereby preventing disorientation of the operators due to the changing space when searching the object with the eye in hand device.

Since the capture control device is disposed on the robot arm directly, the user can use the capture control device to activate the eye in hand device to capture images when moving the robot arm. Therefore, the robot arm with an image capturing function and the method for using a robot arm to capture images provided by the embodiments of the present invention can help the users to operate the robot arm in a much easier way. Furthermore, in the operation mode, the robot arm can control the eye in hand device to capture images automatically. In the manual mode, the operator can control the capture control device disposed on the robot arm to activate the eye in hand device to capture the image of a predetermined object and the captured image can be processed to generate the image file of the predetermined object. The image file of the predetermined object is stored directly as the comparing basis for the future identification so the external image processing operations can be reduced, thereby simplifying the process of operating the robot arm and increasing the usage flexibility of the eye in hand device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A robot arm with an image capturing function comprising:
a body having a first terminal fixed at a base, and a second terminal being a movable portion, the movable portion having an eye in hand device disposed thereon;
a capture control device disposed next to the eye in hand device and configured to activate the eye in hand device to capture images;
a controller coupled to the body and configured to control the body to move the movable portion; and
a display controlled by the controller and configured to display images captured by the eye in hand device;
wherein:
when the robot arm is in an operation mode, the controller controls the eye in hand device to capture images; and
when the robot arm is in a manual mode, the capture control device activates the eye in hand device to capture images.

2. The robot arm of claim 1, wherein the capture control device is a push button or a switch.

3. The robot arm of claim 1, wherein the capture control device is disposed on the movable portion.

4. The robot arm of claim 1, wherein the capture control device is disposed on the body.

5. The robot arm of claim 1, wherein the capture control device is disposed on the eye in hand device.

6. The robot arm of claim 1, wherein the display is disposed on the eye in hand device.

7. The robot arm of claim 1, wherein:
when the robot arm is in the operation mode, the controller controls the body to move the movable portion; and
when the robot arm is in the manual mode, the movable portion is moved by hand.

8. The robot arm of claim 1, wherein the controller comprises a memory and an image processor, the controller controls the memory to store image files of predetermined objects in advance and temporarily store images captured by the eye in hand device, and controls the image processor to process the images temporarily stored in the memory.

9. The robot arm of claim 8, wherein the capture control device activates the eye in hand device to capture an image of a target object, the image processor processes the image of the target object to generate an image file of a predetermined object, and stores the image file in the memory.

10. A method for using a robot arm to capture images comprising:
switching the robot arm to a manual mode;
moving the robot arm manually to bring an eye in hand device close to a target object;
a display displaying an image captured by the eye in hand device;
when the target object shows up in the display, a capture control device activating the eye in hand device to capture an image of the target object;
storing the image of the target object temporarily;
processing the image of the target object to generate an image file of a predetermined object;
storing the image file in a memory;
switching the robot arm to an operation mode;
the robot arm controlling the eye in hand device to capture an image of an object; and
identifying the object according to the image file of the predetermined object.

11. The method of claim 10, further comprising before the target object shows up in the display, keeping moving the robot arm to bring the eye in hand device closer to the target object.

12. The method of claim 10, wherein storing the image of the target object temporarily is storing the image of the target object in the memory of the robot arm temporarily.
